(19) United States
(12) Patent Application Publication
(10) Pub. No.: US 2017/0303562 A1
(43) Pub. Date: Oct. 26, 2017

(54) PET BEVERAGE

(71) Applicant: Petrol Inc., Cornelius, NC (US)

(72) Inventors: Julie Yenichek, Cornelius, NC (US); Ryan Huyghe, New Albany, OH (US)

(21) Appl. No.: 15/493,756

(22) Filed: Apr. 21, 2017

Related U.S. Application Data
(60) Provisional application No. 62/326,132, filed on Apr. 22, 2016.

(51) Int. Cl. A23K 20/174; A23K 20/10

(52) U.S. Cl. CPC A23K 20/174; A23K 20/10

(57) ABSTRACT

Disclosed are pet beverages. In particular, disclosed are vitamin fortified pet beverages.

### CROSS REFERENCE TO RELATED APPLICATIONS

This application claims priority to U.S. Provisional Application No. 62/326,132 filed on Apr. 22, 2016, which is hereby incorporated by reference in its entirety.

### BACKGROUND

The present disclosure relates to a pet beverage, and in particular, a pet beverage that is vitamin fortified.

Domestic pets such as dogs and cats give their owners pleasure and often come to be regarded as family members. Accordingly, pet owners also experience distress when their pets develop allergies to their foods. Such food allergies, which are also known as food hypersensitivities, can manifest themselves by itching, swelling, vomiting, diarrhea (and sometimes even bronchoconstriction and anaphylaxis), and can be difficult to diagnose. Additionally, pet owners may also worry that their pets do not ingest enough nutritional substances to maintain a healthy lifestyle.

Within the class of foods known as pet foods, there are three basic subdivisions, dry pet food, semi-moist pet food, and moist pet food. The moisture is determined by considering both the water present in the final product and the water combined with the various components that make up the final product. In general, the dry pet food—due to its low moisture content which is usually less than about 15 percent—tends to exhibit the greatest microbiological stability and requires no special handling or packaging after processing.

At the opposite end of the spectrum is the moist pet food having moisture content in excess of about 50 percent. Due to the high moisture content of the moist pet food, microbiological stability is a major problem. This problem in a moist pet food is overcome only by heat sterilizing the moist pet food and packaging the moist pet food in a hermetically sealed container. Even with the heat sterilization and hermetically sealed package, refrigeration is required after the package of moist pet food is opened to preserve the leftover pet food for even a short time.

Semi-moist pet food has a moisture content generally ranging from about 15 percent to about 50 percent. Since semi-moist pet foods are higher in moisture content than dry and lower in moisture than canned, special techniques are required to render it microbiologically stable. This moisture content in combination with special techniques may produce a microbiologically stable food which does not require refrigeration. At the same time, the higher moisture content of the semi-moist pet food provides an increased palatability when compared to the dry pet food. The semi-moist pet food is generally rendered microbiologically stable by using high levels of sugar and solutes which can be undesirable.

Moreover, dry pet foods have a hard, brittle, shell structure. Additionally, dry pet foods require some processing and packaging techniques for preserving the food. Additionally, dry pet foods require a dressing (or an additive) to add essential vitamins and minerals. These additives typically do not have nutritional value for the pet. Further, dry pet foods may lack palatability.

Currently, pet foods have disadvantages such as low nutritional value, high manufacturing costs, low palatability and short shelf life. Pet owners require a nutritional supplement that incorporates pleasing favors to the pets, low cost and ease of delivery to the pets.

### BRIEF DESCRIPTION

The present disclosure is generally directed to a pet beverage. In particular, the present disclosure is directed to a pet beverage that is vitamin fortified.

In one aspect, the present disclosure is directed to a liquid mixture comprising: water; a vitamin; and flavoring.

In one aspect, the present disclosure is directed to a liquid mixture comprising water; natural flavoring; a plurality of B-complex vitamins, biotin, niacin, and L-carnitine.

### DETAILED DESCRIPTION

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

The present disclosure relates to a beverage fortified with nutritional ingredients. The beverage can be used in any drink. However, for purposes of illustration only, the beverage will be described as incorporated into a drink for animals such as domesticated animals or pets. Additionally, the pet beverage can be packaged into any volume to accommodate animals of any size.

The present disclosure relates to a liquid mixture comprising water, a vitamin, a compound and a carrier. Optimally, the water comprises a base of reverse osmosis. However, any water base that is easily used for its intended purpose is acceptable. In one embodiment, the vitamin comprises a Vitamin C. In another embodiment, the vitamin comprises a Vitamin B. Still further, in another embodiment, the carrier comprises an acid such as but not limited to a citric acid. The below tables further illustrate ingredients of the pet beverages of the present disclosure wherein Table 1 optimally includes a Use Rate of 240 mg/liter and Table 2 optimally includes a Use Rate of 9 mg/liter. The ingredients and amounts are representative of embodiments and not intended to limit the scope of the disclosure. Any volume and Use Rate may be used in the present disclosure.

TABLE 1
Embodiment

| | NUTRIENT | INGREDIENT |
|---|---|---|
| ACTIVE INGREDIENTS | LEVEL¹ | LEVEL² |
| Ascorbic Acid (Vitamin C) | 100 mg | 200 mg |
| L-Carnitine | 20 mg | 21.3 mg |
| Carrier (Citric Acid) | | Quantity Standard |
| Chlorophyll (sodium) | 10 mg | |
| Copper chlorophyllin | | |

¹For use in determining percent of daily value for the “Nutrition Facts” label panel.
²For use in determining ingredient legend declaration. Includes overages and compensation for marked forms that are not 100% potency.

TABLE 2
Embodiment

| | NUTRIENT | INGREDIENT |
|---|---|---|
| ACTIVE INGREDIENTS | LEVEL¹ | LEVEL² |
| Biotin (Vitamin B8) | 0.03 mg | 3.45 mg |
| Niacinamide (Vitamin B3) | 3.3 mg | 3.65 mg |
| Pyridoxine Hydrochloride | 0.3 mg | 0.44 mg |
| (Vitamin B6) | | |
| Riboflavin (Vitamin B2) | 0.63 mg | 0.78 mg |
| Thiamine Hydrochloride | 0.3 mg | 0.36 mg |
| (Vitamin B1) | | |
| Carrier (Citric Acid) | | Quantity Standard |

¹For use in determining percent of daily value for the “Nutrition Facts” label panel
²For use in determining ingredient legend declaration. Includes overages and compensation for market forms that are not 100% potency.

In another embodiment, the ingredients of the present disclosure include ascorbic acid (Vitamin C) at 100 mg/liter; L-Carnitine at 20 mg/liter and chlorophyll (sodium copper chlorophyllin) at 10 mg/liter wherein the amounts listed are per liter of finished water.

Still further, in another embodiment, the ingredients of the present disclosure include Vitamin B1 (thiamin) at 0.3 mg/liter; Vitamin B2 (riboflavin) at 0.63 mg/liter, Vitamin B6 (pyridoxine) at 0.30 mg/liter, Biotin at 0.03 mg/liter and Niacin at 3.3 mg/liter wherein the amounts listed are per liter of finished water.

The pet beverage of the present disclosure also comprises a flavor. Optimally, the flavor comprises a flavor blend that is all natural with no allergens or no animal products. Any flavor or flavor blend that is easily used for its intended purpose is acceptable.

The present disclosure relates to another liquid mixture comprising water, a flavor and a vitamin. Optimally, the water comprises a base of reverse osmosis. However, any water base that is easily used for its intended purpose is acceptable. The present disclosure provides palate-pleasing flavor and added nutrients beneficial for a pet's health. In an embodiment, the beverage includes: 100% reverse osmosis water for purity and wholesomeness; 100% natural flavorings, B-Complex vitamins for overall health and metabolic function; Biotin and Niacin for healthy skin and coat; L-Carnitine for weight control and lean muscle; low calorie; preservative free and no meat or meat by-product ingredients. Further, in an embodiment, the calculated calorie content is 21 kcal ME/Liter; 8 kcal/12 oz.

In one embodiment, the mixture includes the ingredients listed in Table 3. The amount listed is per Liter of finished water. The ingredients and amounts are representative of embodiments and not intended to limit the scope of the disclosure.

TABLE 3
Embodiment

| INGREDIENTS | AMOUNT |
|---|---|
| Vitamin B1 (thiamin) | 0.3 mg/L |
| Vitamin B2 (riboflavin) | 0.63 mg/L |
| Vitamin B6 (pyridoxine) | 0.30 mg/L |
| Biotin * | 0.03 mg/L |
| Niacin | 3.3 mg/L |
| L-carnitine* | 20 mg/L |

* Not recognized as an essential nutrient by the Associate of American Feed Control Officials (AAFCO).

In another embodiment, the mixture includes the ingredients listed in Table 4. The amount listed is for 12 Oz (0.355 mL) of water. The ingredients and amounts are representative of embodiments and not intended to limit the scope of the disclosure.

TABLE 4
Embodiment

| INGREDIENTS | AMOUNT |
|---|---|
| Vitamin B1 (thiamin) | 0.11 mg |
| Vitamin B2 (riboflavin) | 0.23 mg |
| Vitamin B6 (pyridoxine) | 0.11 mg |
| Biotin * | 0.01 mg |
| Niacin | 1.2 mg |
| 2 L-carnitine* | 7.26 mg |

* Not recognized as an essential nutrient by the Associate of American Feed Control Officials (AAFCO).

Optimally, the flavor comprises a flavor blend that is all natural with no allergens or no animal products. Any flavor or flavor blend that is easily used for its intended purpose is acceptable.

The present disclosure relates to another liquid mixture comprising water, a vitamin, a compound and a carrier. Optimally, the water comprises a base of reverse osmosis. However, any water base that is easily used for its intended purpose is acceptable.

In one embodiment, the vitamin comprises a Vitamin C. In another embodiment, the vitamin comprises a Vitamin B. Still further, in another embodiment, the carrier comprises an acid such as but not limited to a citric acid. The below tables further illustrate ingredients of the pet beverages of the present disclosure wherein Table 5 optimally includes a Use Rate of 31 mg/liter. The ingredients and amounts are representative of embodiments and not intended to limit the scope of the disclosure. Any volume and Use Rate may be used to in the present disclosure.

TABLE 5
Embodiment

| | NUTRIENT | INGREDIENT |
|---|---|---|
| ACTIVE INGREDIENTS | LEVEL³ | LEVEL⁴ |
| Biotin (Vitamin B8) | 0.03 mg | 3.00 mg |
| Niacinamide (Vitamin B3) | 3.3 mg | 3.32 mg |
| Pyridoxine (as Pyridoxine | 0.3 mg | 0.36 mg |
| Hydrochloride, B6) | | |
| Riboflavin (Vitamin B2) | 0.63 mg | 0.65 mg |
| Thiamine | 0.3 mg | 0.3 mg |
| (as Hydrochloride, B1) | | |
| L-Carnitine | 20 mg | 20.3 mg |
| Carrier (Citric Acid) | | Q.S. |

³For use in determining percent of daily value for the “Nutrition Facts” label panel.
⁴For use in determining ingredient legend declaration. Includes overages and compensation for market forms that are not 100% potency.

1. A liquid mixture for comprising: water; a vitamin; and flavoring.

2. The liquid mixture of claim 1 further comprising ingredients of Table 1.

3. The liquid mixture of claim 1 further comprising ingredients of Table 2.

4. The liquid mixture of claim 1 further comprising ingredients of Table 3.

5. The liquid mixture of claim 1 further comprising ingredients of Table 4.

6. The liquid mixture of claim 1 further comprising ingredients of Table 5.

7. A liquid mixture comprising water; natural flavoring; a plurality of B-complex vitamins, biotin, niacin, and L-carnitine.

8. The liquid mixture of claim 7, wherein the calorie content is 21 kcal ME/Liter.

9. The liquid mixture of claim 7, wherein the B-complex vitamins comprises Vitamin B1, Vitamin B2, and Vitamin B6.

10. The liquid mixture of claim 7, further comprising Vitamin C.

11. The liquid mixture of claim 7, further comprising citric acid.
